(19) United States
(12) Patent Application Publication
(10) Pub. No.: US 2025/0252389 A1
(43) Pub. Date: Aug. 7, 2025

(54) DELIVERY PLAN GENERATION APPARATUS

(71) Applicant: TOYOTA JIDOSHA KABUSHIKI KAISHA, Toyota-shi (JP)

(72) Inventor: Keisuke MORISAKI, Toyota-shi (JP)

(73) Assignee: TOYOTA JIDOSHA KABUSHIKI KAISHA, Toyota-shi (JP)

(21) Appl. No.: 18/924,119

(22) Filed: Oct. 23, 2024

(30) Foreign Application Priority Data
Feb. 6, 2024 (JP) 2024-016353

(51) Int. Cl. G06Q 10/0835; G06Q 10/0834

(52) U.S. Cl. CPC G06Q 10/08355; G06Q 10/0834

(57) ABSTRACT

A plurality of vehicles includes a first vehicle that does not include an internal combustion engine as a power source and includes an electric motor, and a second vehicle that includes an internal combustion engine as a power source. The total load weight of the cargo loaded on the vehicle when the delivery of the second delivery route is started is larger than the total load weight of the cargo loaded on the vehicle when the delivery of the second delivery route is started. The delivery plan generation device performs a process of determining a delivery route of the first vehicle and the second vehicle so that, among the first delivery route and the second delivery route, the first delivery route is preferentially assigned to the first vehicle rather than to the second delivery route.

### CROSS-REFERENCE TO RELATED APPLICATION

This application claims priority to Japanese Patent Application No. 2024-016353 filed on Feb. 6, 2024, incorporated herein by reference in its entirety.

### BACKGROUND

### 1. Technical Field

The present disclosure relates to a delivery plan generation apparatus, and more particularly, to a delivery plan generation apparatus that generates a delivery plan of a plurality of vehicles that deliver packages.

### 2. Description of Related Art

Japanese Unexamined Patent Application Publication No. 2023-133750 (JP 2023-133750 A) discloses a transportation planning system that assigns transportation paths to a plurality of vehicles having different power sources. A plurality of vehicles provided with different power sources include a battery electric vehicle (BEV) provided with, as a power source, an electric motor without an internal combustion engine, and a vehicle provided with an internal combustion engine as a power source.

The transportation planning system is configured to assign the BEV to a first transportation path through a first transportation destination in a first transportation area defined with reference to a position of a charging station at which a vehicle is charged. This enables the BEV to be charged by stopping at a charging station in the middle of the conveyance path so that the remaining charge amount does not become insufficient.

### SUMMARY

However, in a case where a vehicle is charged in the middle of the conveyance path (delivery route), the vehicle cannot be moved while being charged, causing a reduction in the delivery efficiency. In order to suppress such a reduction in the delivery efficiency, there is still room for improvement in how to assign vehicles including a BEV to appropriate delivery routes.

The present disclosure has been made to solve the problem described above, and an object of the present disclosure is to provide a delivery plan generation apparatus capable of suppressing a reduction in delivery efficiency in a delivery plan of a plurality of vehicles provided with an electric motor or an internal combustion engine.

The delivery plan generation apparatus of the present disclosure is an apparatus that generates a delivery plan of a plurality of vehicles that deliver packages. The delivery plan generation apparatus includes:
a processor; and
a memory that stores a program executable by the processor.
The vehicles include a first vehicle provided with, as a power source, an electric motor without an internal combustion engine, and at least one second vehicle provided with an internal combustion engine as a power source.
The delivery routes of the vehicles include a first delivery route and a second delivery route. The total loading weight of the packages loaded on the vehicle when the delivery on the second delivery route is started is larger than the total loading weight of the packages loaded on the vehicle when the delivery on the first delivery route is started.
The processor performs a process including determining delivery routes of the first vehicle and the at least one second vehicle so as to assign the first delivery route, out of the first delivery route and the second delivery route, preferentially to the first vehicle rather than to the at least one second vehicle.

The first vehicle provided with, as a power source, an electric motor without an internal combustion engine has a shorter cruisable distance and a longer required charging time than the second vehicle provided with an internal combustion engine as a power source. According to such a configuration, the first vehicle is preferentially assigned to the first delivery route with a small total loading weight, whereby in the first vehicle, a deterioration in electricity consumption due to the weight of the loaded packages is suppressed. Therefore, it is possible to reduce the possibility that the first vehicle is charged by stopping at the charging station during delivery. This makes it possible to suppress a reduction in the delivery efficiency in a delivery plan of a plurality of vehicles provided with an electric motor or an internal combustion engine.

In the delivery plan generation apparatus described above, delivery destinations on the first delivery route include a first delivery destination and a second delivery destination.
The weight of the package delivered to the second delivery destination is larger than the weight of the package delivered to the first delivery destination.
When the first vehicle is assigned to the first delivery route, the processor performs a process including determining delivery order for the first delivery route such that the second delivery destination has a higher priority than the first delivery destination.

According to such a configuration, since the first vehicle performs delivery while prioritizing the destination to which a heavier one of the packages is to be delivered, an average value of the loading weights of the packages is reduced on the delivery route, then the possibility is reduced that the first vehicle is charged during delivery. This makes it possible to suppress a reduction in the delivery efficiency.

In the delivery plan generation apparatus described above, the delivery routes of the vehicles further include a third delivery route.
The total loading weight of the packages loaded on the vehicle when the delivery on the third delivery route is started is larger than the total loading weight of the packages loaded on the vehicle when the delivery on the second delivery route is started.
The at least one second vehicle includes a third vehicle provided with, as a power source, an internal combustion engine without an electric motor, a fourth vehicle provided with an electric motor and an internal combustion engine as power sources without having an external charging function, and a fifth vehicle being externally chargeable and provided with an electric motor and an internal combustion engine as power sources.
The processor performs a process including determining delivery routes of the third vehicle, the fourth vehicle, and the fifth vehicle such that the second delivery route is preferentially assigned out of the second delivery route and the third delivery route in order of the third vehicle, the fourth vehicle and the fifth vehicle.

According to such a configuration, out of the fourth and fifth vehicles capable of using the electric motor as a power source, the fifth vehicle using the electric motor as a power source with a higher frequency is assigned preferentially to the third delivery route with a large total loading weight. The delivery route with a large total loading weight is also a delivery route on which the vehicle consumes large amounts of energy due to traveling (traveling for a long distance with heavy packages loaded). Therefore, such a configuration makes it possible to establish a delivery plan in which the vehicle travels using an electric motor as a power source as much as possible in consideration of the natural environment.

In the delivery plan generating apparatus, traveling modes of the fifth vehicle include a first mode in which the fifth vehicle travels using an electric motor and an internal combustion engine, and a second mode in which the fifth vehicle travels using an electric motor without using an internal combustion engine.
The processor performs a process including transmitting, to the fifth vehicle, a command to travel in the first mode when a current loading weight of the fifth vehicle is equal to or greater than a specified value and a command to travel in the second mode when the current loading weight of the fifth vehicle is less than the specified value while the fifth vehicle is delivering the packages on the assigned delivery route.

According to such a configuration, the fifth vehicle travels in the first mode in which the vehicle travels using an electric motor and an internal combustion engine when the current loading weight is equal to or greater than the specified value. Furthermore, the fifth vehicle travels in the second mode in which the vehicle travels using an electric motor without using an internal combustion engine when the current loading weight is less than the specified value. This makes it possible to avoid traveling in the second mode using only an electric motor in a state where the loading weight is large and the electricity consumption is deteriorated, and to travel in the second mode in a state where the loading weight is small and the electricity consumption is increased.

According to the present disclosure, it is possible to suppress a reduction in the delivery efficiency in the delivery plan of a plurality of vehicles provided with an electric motor or an internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a delivery plan generation system according to a first embodiment;

FIG. 2 is a diagram for explaining assignment of a delivery route according to the first embodiment;

FIG. 3 is a flowchart illustrating a processing procedure of processing executed by the delivery plan generation system according to the first embodiment;

FIG. 4 is a flow chart showing a process sequence of a process executed by the delivery planning generation system according to the second embodiment; and

FIG. 5 is a flowchart illustrating a processing procedure of the mode-specific processing according to the third embodiment.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

### First Embodiment

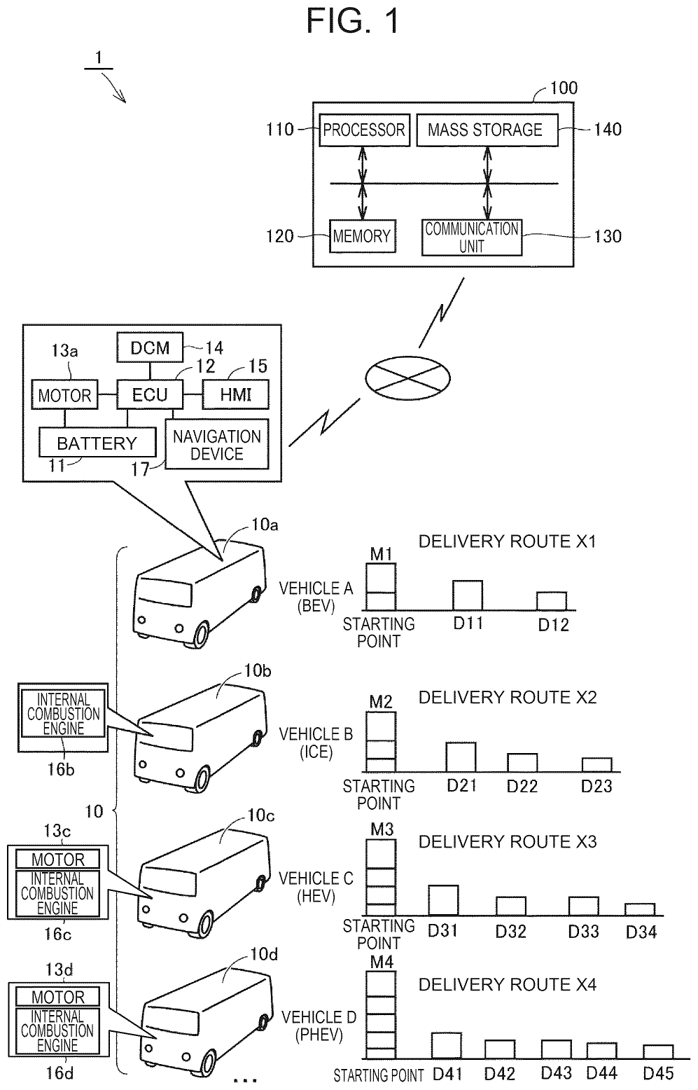

FIG. 1 is a diagram schematically illustrating an overall configuration of a delivery plan generation system 1 according to a first embodiment. The delivery plan generation system 1 includes a plurality of vehicles 10 that delivers packages, and a delivery plan generation apparatus 100. The plurality of vehicles 10 and the delivery plan generation apparatus 100 can communicate with each other via a communication network.

The delivery plan generation apparatus 100 is a device that generates a delivery plan for a plurality of vehicles 10 that delivers a package. The delivery plan generation apparatus 100 performs a process of determining a delivery vehicle from among a plurality of vehicles 10 owned by the delivery company for each of a plurality of delivery areas (delivery routes) managed by the delivery company. The plurality of vehicles 10 includes 10d from the vehicle 10a. The vehicle 10a illustrated in FIG. 1 is also referred to as a vehicle A, the vehicle 10b is also referred to as a vehicle B, the vehicle 10c is also referred to as a vehicle C, and the vehicle 10d is also referred to as a vehicle D.

Here, the vehicle 10a (vehicle A) corresponds to the “first vehicle” according to the present disclosure. Vehicles 10b to 10d (vehicles B to D) correspond to “at least one second vehicle” according to the present disclosure. The vehicle 10b (vehicle B) corresponds to the “third vehicle” according to the present disclosure. The vehicle 10c (vehicle C) corresponds to the “fourth vehicle” according to the present disclosure. The vehicle 10d (vehicle D) corresponds to a “fifth vehicle” according to the present disclosure.

Vehicle A (vehicle 10a) is an electrified vehicle that can be externally charged from a charging facility (EVSE: Electric Vehicle Supply Equipment), and is a battery electric vehicle (BEV: Battery Electric Vehicle) provided with an electric motor 13a without an internal combustion engine as a power source. On the other hand, the vehicle B to the vehicle D (the vehicle 10b to 10d) are vehicles that can travel using at least a power source that differs from the electric motor, and are vehicles that include an internal combustion engine as a power source.

Vehicle A includes a battery 11, an ECU (Electronic Control Unit) 12, an electric motor 13a, a DCM (Data Communication Module) 14, an HMI(Human Machine Interface) 15, and a navigational device 17 that processes position data detected by GPS. The battery 11 stores power used for traveling of the vehicle A. The battery 11 is constituted by, for example, a lithium-ion battery. The electric motor 13a is driven using the electric power of the battery 11. DCM 14 is a module for communicating with an external device via a communication network, and transmits data from ECU 12 to the external device, and transfers data from the external device to ECU 12. HMI 15 is provided in the vicinity of the driver's seat of the vehicle A. HMI 15 receives information inputted from the user and outputs the received information to ECU 12, or displays or audibly notifies the user of the information from ECU 12. HMI 15 includes, for example, a touch panel display.

The vehicle B is an engine vehicle (hereinafter, also referred to as an ICE (Internal Combustion Engine)) that does not include an electric motor as a power source and includes an internal combustion engine 16b. Vehicle C is a hybrid electric vehicle (HEV: Hybrid Electric Vehicle) that does not have an external charge function and includes an electric motor 13c and an internal combustion engine 16c as a power source. Vehicle D is a plug-in hybrid electric vehicle (PHEV: Plug-in Hybrid Electric Vehicle) that can be externally charged from a charging facility and includes an electric motor 13d and an internal combustion engine 16d as a power source.

The plurality of vehicles 10 also includes a fuel cell electric vehicle (FCV: Fuel Cell Vehicle). FCV includes a power generation device (not shown) including a hydrogen tank (not shown) for storing hydrogen and a fuel cell (not shown) for generating electricity by a chemical reaction between hydrogen and oxygen, and a battery (not shown). The fuel cell generates electric power using hydrogen supplied from a hydrogen tank. Electric power generated by the power generation device is used to drive a driving motor of FCV or is stored in a battery. The user of FCV can replenish the hydrogen at a hydrogen station installed in the town. The time for charging hydrogen at the hydrogen station is a short time compared to the charging time of the battery 11 of the vehicle A (BEV).

The delivery plan generation apparatus 100 includes a processor 110 (e.g., a CPU), a memory 120 that stores programs executable by the processor 110, a communication unit 130, and a mass storage device 140. The memory 120 includes RAM (Random Access Memory) and ROM (Read Only Memory). The communication unit 130 can communicate with an external device via a communication network. The mass storage device 140 includes an HDD (Hard Disk Drive) or an SSD (Solid State Drive), and stores programs and data used by the processor 110. The processor 110 executes programs stored in the memory 120 or the mass storage device 140.

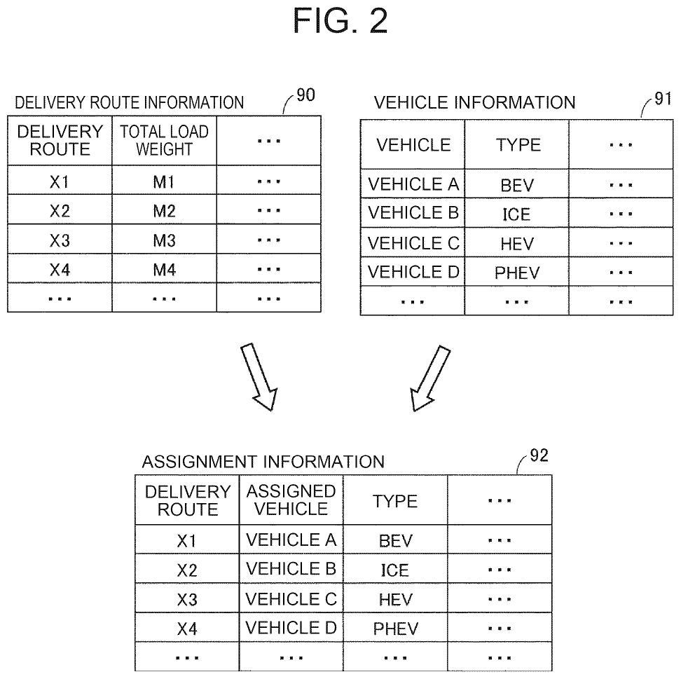

FIG. 2 is a diagram for explaining assignment of a delivery route according to the first embodiment. The mass storage device 140 stores delivery route information 90, vehicle information 91, and assignment information 92.

The delivery route information 90 stores the total load weight of each delivery route, information on the delivery destination in the delivery route, and the like. Here, the “total load weight” indicates the total load weight (units: kg) of the cargo loaded on the vehicles when the delivery of the respective delivery routes (X1 to X4) is started. The delivery routes of the plurality of vehicles 10 include the delivery routes X1 to X4. It is recorded in the delivery route information 90 that the total load weight of the delivery route X1 is M1, the total load weight of the delivery route X2 is M2, the total load weight of the delivery route X3 is M3, and the total load weight of the delivery route X4 is M4.

When the vehicle 10 (any of the vehicle A to the vehicle D and the like) is assigned to the delivery route, the vehicle 10 travels through the assigned delivery route to perform delivery.

Here, it is assumed that the relationship of the total payload is M1<M2<M3<M4. For example, the total load weight M2 of the cargo loaded on the vehicle when the delivery route X2 is started is larger than the total load weight M1 of the cargo loaded on the vehicle when the delivery route X1 is started. The total load weight M3 of the cargo loaded on the vehicle when the delivery route X3 is started is larger than the total load weight M2 of the cargo loaded on the vehicle when the delivery route X2 is started. Here, the delivery route X1 corresponds to the “first delivery route” according to the present disclosure, the delivery route X2 corresponds to the “second delivery route” according to the present disclosure, and the delivery route X3 corresponds to the “third delivery route” according to the present disclosure.

In the vehicle information 91, the type of each vehicle is recorded. In the vehicle information 91, it is recorded that the vehicle A is BEV, the vehicle B is ICE, the vehicle C is HEV, and the vehicle D is PHEV.

In the assignment information 92, a result of assigning any one of the vehicles A to D and the like to each delivery route is recorded based on the delivery route information 90 and the vehicle information 91. In the assignment information 92, the assigned vehicle, the type, and the like corresponding to each delivery route are recorded.

In the assignment information 92, it is recorded that the assigned vehicle for the delivery route X1 is the vehicle A (BEV), the assigned vehicle for the delivery route X2 is the vehicle B (ICE), the assigned vehicle for the delivery route X3 is the vehicle C (HEV), and the assigned vehicle for the delivery route X4 is the vehicle D (PHEV). This is also illustrated in FIG. 1.

Return to FIG. 1. The delivery destination in the delivery route X1 to which the vehicle A is assigned includes a delivery destination D11 and a delivery destination D12. The weight of the package delivered to the delivery destination D11 is greater than the weight of the package delivered to the delivery destination D12. The total load weight of the package to be delivered to the delivery destination D11 and the delivery destination D12 is M1, and these packages are loaded at the point of departure at the time of delivery. Here, the delivery destination D12 corresponds to the “first delivery destination” according to the present disclosure, and the delivery destination D11 corresponds to the “second delivery destination” according to the present disclosure.

In the delivery route X2 to which the vehicle B is assigned, the total load weight of the package to be delivered from the delivery destination D21 to D23 is M2, and these packages are loaded at the departure point at the time of delivery. In the delivery route X3 to which the vehicle C is assigned, the total load weight of the package to be delivered from the delivery destinations D31 to D34 is M3, and these packages are loaded at the departure point at the time of delivery. In the delivery route X4 to which the vehicle D is assigned, the total load weight of the packages to be delivered to the delivery destinations D41 to D45 is M2, and these packages are loaded at the departure point at the time of delivery.

In FIG. 1, a vehicle A (BEV), a vehicle B (ICE), a vehicle C (HEV), and a vehicle D (PHEV) are assigned in descending order of the total load weight.

The delivery plan generation apparatus 100 performs a process of determining a delivery route for the vehicle A and the vehicles B to D such that, among the delivery route X1 and the delivery route X2 (or X3, X4), the vehicle A (BEV) is preferentially assigned to the delivery route X1 over the vehicle B to the vehicle D (ICE, HEV, PHEV).

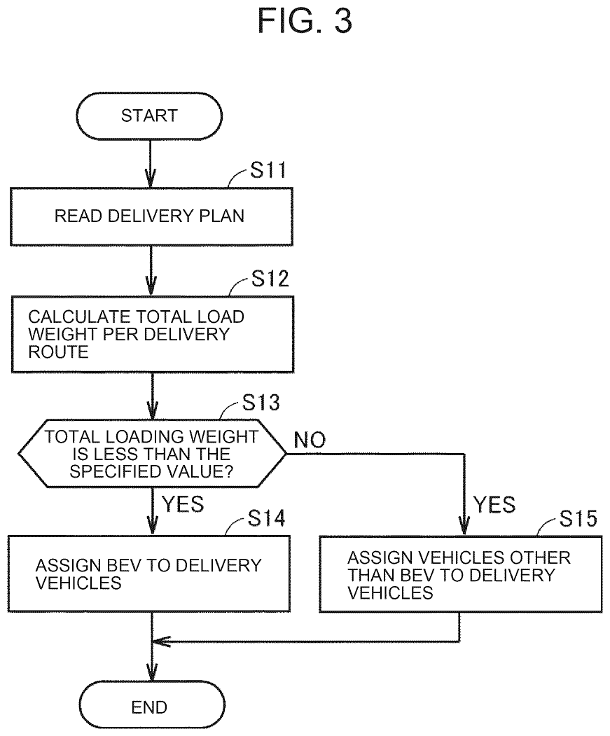

Hereinafter, a description will be given with reference to a flowchart. FIG. 3 is a flowchart illustrating a processing procedure of processing executed by the generation system according to the first embodiment. Hereinafter, the step will be simply referred to as “S”.

First, the delivery plan generation apparatus 100 reads the delivery plan in S11. In a specific example given using FIGS. 1 and 2, the delivery plan generation apparatus 100 holds the delivery route information 90 and the vehicle information 91. The delivery plan generation apparatus 100 reads information such as X4 and information such as D (delivery route information 90 and vehicle information 91) from the vehicle A from the delivery route X1 as a delivery plan.

The delivery plan generation apparatus 100 calculates the total load weight for each delivery route in S12. In the present embodiment, for example, the delivery destination of the delivery route X1 is the delivery destinations D11, D12 (see FIG. 1). The weight of the package to be delivered to the delivery destination D11+the weight of the package to be delivered to the delivery destination D12=the total load weight M1 is calculated and recorded in the delivery route information 90.

In S13, the delivery plan generation apparatus 100 determines whether the total load weight is less than a specified value. In the present embodiment, it is assumed that the total load weight M1<the specified value in the delivery route X1<the total load weight M2 in the delivery route X2<the total load weight M3 in the delivery route X3<the total load weight M4 in the delivery route X4.

When the total load weight in the delivery route is less than the specified value (YES by S13), the delivery plan generation apparatus 100 assigns a BEV to the delivery vehicles (S14). In the present embodiment, the delivery route X1 is assigned to vehicle A (BEV) (see FIG. 1 and FIG. 2) because the total load weight M1 in the delivery route X1 is less than the specified value. That is, the delivery route X1 is assigned to the vehicle A (BEV) preferentially from the delivery routes X2 to X4.

When the total load weight in the delivery route is equal to or greater than the specified value (NO by S13), the delivery plan generation apparatus 100 assigns a vehicle other than BEV to the delivery vehicle (S15). In the present embodiment, the vehicles B to D (ICE, HEV, PHEV) are respectively assigned to X4 from the delivery route X2 whose total load weight is equal to or greater than the specified value (see FIGS. 1 and 2).

In order to realize carbon neutral, the delivery company also needs to introduce BEV from the conventional ICE. A vehicle A (BEV) having an electric motor 13a without an internal combustion engine as a power source has an inconvenience of being shorter in cruising range than vehicles B to D (ICE, HEV, PHEV) provided with an internal combustion engine as a power source and requiring longer times for recharging. Because of the short cruising range, BEV is more likely to need to be charged in the middle. If charging is performed during delivery, it will be down time and labor costs will increase, so we would like to avoid charging as much as possible. In addition, it is not good for the delivery driver to drive while having anxiety about the cruising distance because of the mental stability. On the other hand, in ICE, HEV, PHEV, the cruising distance is longer than that of BEV, and even if the fueling is required, the fueling time is shorter than that of BEV.

As described above, the delivery plan generation apparatus 100 performs a process of determining the delivery routes for the vehicle A and the vehicles B to D such that, out of the delivery route X1 and the delivery route X2 (X3, X4), the vehicle A (BEV) is preferentially allocated to the delivery route X1 over the vehicle B to the vehicle D (ICE, HEV, PHEV). With such a configuration, by preferentially allocating the vehicle A to the delivery route X1 having a smaller total load weight, deterioration of the electric power cost due to the weight of the loaded cargo can be suppressed in the vehicle A, and the possibility of stopping at the charging station during delivery and performing charging can be reduced. As a result, it is possible to suppress a decrease in the delivery efficiency in the delivery plan of the plurality of vehicles 10 including the electric motor or the internal combustion engine. Note that “vehicles other than BEV” in S15 include FCV. Since the time for charging hydrogen at the hydrogen station of FCV is also shorter than the charging time of BEV, the above-mentioned BEV problem does not arise.

It should be noted that BEV is not limited to the case where the total load weight in the delivery route is less than the specified value, and the total load weight may be preferentially assigned to BEV in order from the smaller delivery route. In this case, the total loading weight may be equal to or greater than the specified value or may be assigned to a BEV, or may be assigned to vehicles other than BEV even if the total loading weight is less than the specified value, or may be preferentially assigned to a delivery route having a smaller total loading weight to BEV. In addition, when the allocation is performed to BEV, the delivery route may be determined so that the total loading weight is less than the specified value. It should be noted that the vehicle 10 may be assigned to each delivery area to determine a delivery route for delivery within the assigned delivery area, or the vehicle 10 may be assigned to each delivery route.

### Second Embodiment

In the second embodiment, when the vehicle A (BEV) is assigned to the delivery route X1, the delivery plan generation apparatus 100 performs a process of determining the delivery order of the delivery route X1 so as to preferentially deliver the delivery destination D11 having a larger weight of the package to be delivered than the delivery destination D12 to the destination.

Further, the delivery plan generation apparatus 100 performs a process of determining the delivery routes of the vehicle B, the vehicle C, and the vehicle D so as to preferentially assign the delivery route X2 having the lighter total load weight in the order of the vehicle B (ICE), the vehicle C (HEV), and the vehicle D (PHEV) among the delivery route X2 and the delivery route X3. Similarly, in the comparison between the delivery route X3 and the delivery route X4, the delivery route X3 having the lighter total load weight is allocated in the order of ICE, HEV, PHEV. Conversely, the distribution routes with the heavier total load are assigned in PHEV, HEV, ICE order.

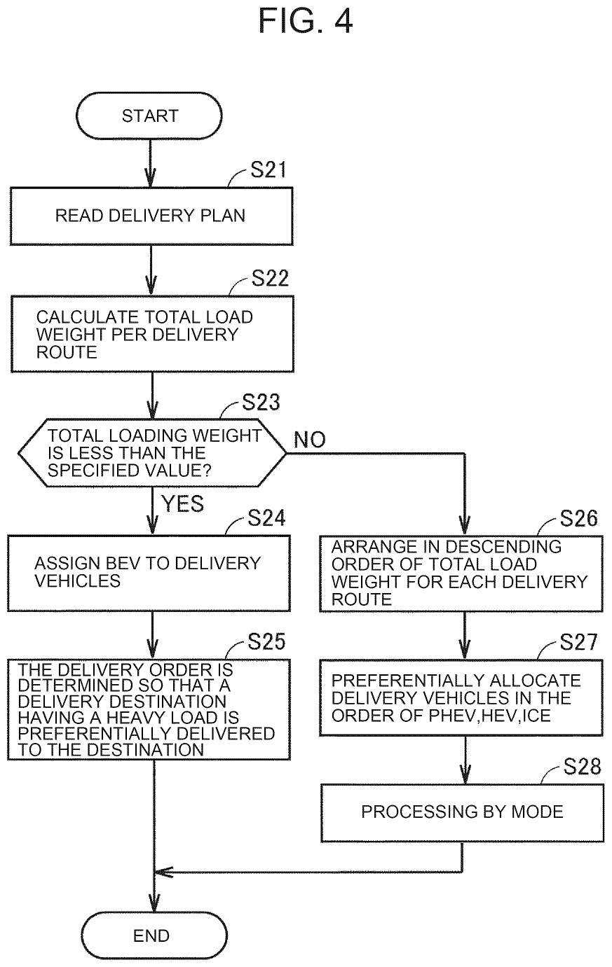

Hereinafter, differences from the first embodiment will be described, and description of the same points as those of the first embodiment will be omitted. FIG. 4 is a flowchart illustrating a processing procedure of processing executed by the delivery plan generation system 1 according to the second embodiment.

The delivery plan generation apparatus 100 reads the delivery plan in S21. The delivery plan generation apparatus 100 calculates the total load weight for each delivery route in S22. The delivery plan generation apparatus 100 assigns BEV to the delivery vehicles when the total load weight in the delivery route is less than the specified value (YES in S23) (S24).

Processing from S21 to S24 is the same as processing from S11 to S14, and thus detailed explanation thereof is omitted. In the above-described embodiment, in S24, the vehicle A (BEV) is allocated to the delivery route X1. The weight of the package delivered to the delivery destination D11 in the delivery route X1 is greater than the weight of the package delivered to the delivery destination D12.

In S25, the delivery plan generation apparatus 100 determines a delivery order such that a delivery destination having a heavy load is preferentially delivered to the destination. In the present embodiment, as illustrated in FIG. 1, in the delivery route X1, after delivery is performed to the delivery destination D11, delivery is performed to the delivery destination D12.

When the total load weight in the delivery route is equal to or greater than the specified value (YES in S23), the delivery plan generation apparatus 100 arranges the total load weights in descending order of the total load weights for the respective delivery routes (S26). In the present embodiment, the delivery route whose total loading weight is equal to or greater than the specified value is X4 from the delivery route X2. The total load weight M4 of the delivery route X4>the total load weight M3 of the delivery route X3>the total load weight M4 of the delivery route X2. The delivery routes are arranged in the order of the delivery routes X4, X3, X2.

In S27, the delivery plan generation apparatus 100 preferentially assigns the arranged delivery routes, from the first delivery route (in the descending order of the total load weight), to vehicles in the order of PHEV, HEV, ICE. In the present embodiment, the vehicle B is ICE, the vehicle C is HEV, and the vehicle D is PHEV. Therefore, the vehicle D (PHEV) having the highest priority is allocated to the first delivery route X4. Next, the next highest-priority vehicle C (HEV) is assigned to the second delivery route X3. Finally, the last remaining vehicle B (ICE) of the lowest priority is assigned to the third delivery route X2.

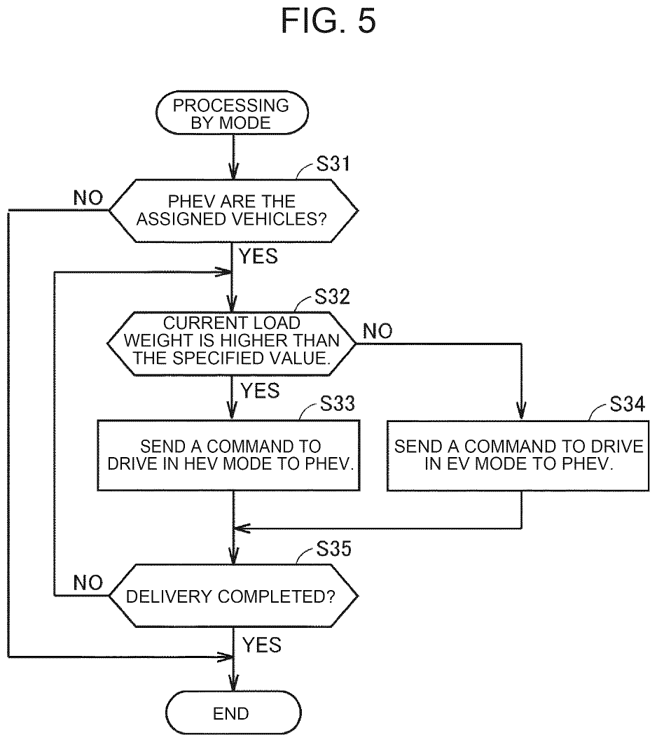

The delivery plan generation apparatus 100 executes a mode-specific process in S28. In the second embodiment, this process (S28) is not performed, but in the third embodiment, the process described in FIG. 5 is performed.

As described above, when the vehicle A (BEV) is assigned to the delivery route X1, the delivery plan generation apparatus 100 performs a process of determining the delivery order of the delivery route X1 so as to preferentially deliver the delivery destination D11 to the destination over the delivery destination D12. According to such a configuration, the delivery of the heavy load is preferentially delivered to the destination rather than the optimization of the route path. Vehicle A (BEV) preferentially delivers a delivery destination D11 having a large weight of a package to be delivered to a destination, so that the mean load weight of the package in the delivery route X1 becomes small, and the possibility of charging during delivery becomes low. This makes it possible to suppress a reduction in the delivery efficiency. It should be noted that although the delivery destination may be determined in descending order of the weight of the load, the delivery order may be determined in consideration of the distance to the delivery destination so as not to generate a route that is unnecessarily distant.

Further, the delivery plan generation apparatus 100 performs a process of determining the delivery routes of the vehicle B, the vehicle C, and the vehicle D so as to preferentially assign the delivery route X2 among the delivery route X3 and the delivery route X2 in the order of the vehicle B (ICE), the vehicle C (HEV), and the vehicle D (PHEV). According to such a configuration, in the vehicles C, D where the electric motor can be used as the power source, the vehicle D, which is frequently used as the power source, among the electric motors, is preferentially assigned to the delivery route X3 having a large total load weight. The delivery route with a large total loading weight is also a delivery route on which the vehicle consumes large amounts of energy due to traveling (traveling for a long distance with heavy packages loaded). Therefore, such a configuration makes it possible to establish a delivery plan in which the vehicle travels using an electric motor as a power source as much as possible in consideration of the natural environment.

### Third Embodiment

In the third embodiment, as in the second embodiment, the processing illustrated in FIG. 4 is executed. In the third embodiment, the mode-specific process executed by S28 is as shown in FIG. 5. FIG. 5 is a flowchart illustrating a processing procedure of the mode-specific processing according to the third embodiment.

The traveling mode of the vehicle D (PHEV) includes an HEV mode in which the vehicle travels using an electric motor 13d and an internal combustion engine 16d, and an EV mode in which the vehicle travels with an electric motor 13d without using an internal combustion engine 16d. Here, HEV mode corresponds to the “first mode” according to the present disclosure, and EV mode corresponds to the “second mode” according to the present disclosure.

In the third embodiment, when the vehicle D is delivering the assigned delivery route, the delivery plan generation apparatus 100 performs a process of traveling in HEV mode when the current load weight of the vehicle D is equal to or greater than the specified value, and transmitting a command to travel in EV mode when the current load weight of the vehicle D is less than the specified value to the vehicle D. Hereinafter, differences from the second embodiment will be described, and description of the same points as those of the second embodiment will be omitted.

When the assigned vehicle is PHEV (YES in S31), the delivery plan generation apparatus 100 advances the process to S32, and when the assigned vehicle is not PHEV (NO in S31), the process ends. For example, in the above-described embodiment, S32 and subsequent processes are performed on the vehicle D (PHEV) assigned to the delivery route X4.

The delivery plan generation apparatus 100 transmits a command to drive in HEV mode to PHEV when the present load weight is equal to or greater than a specified value (YES in S32) (S33). The delivery plan generation apparatus 100 transmits a command to PHEV to drive in EV mode. (S34) When the present load weight is less than the specified value (NO in S32). In the delivery route X4, the total load weight M4 for the vehicle D (PHEV) is equal to or greater than the specified value. Therefore, the vehicle D is set to HEV mode and starts traveling of the delivery route X4 (see FIG. 1).

When the delivery in the delivery route has ended (YES in S35), the delivery plan generation apparatus 100 ends the present process, and when the delivery in the delivery route has not ended (NO in S35), returns the process to S32. As a result, when the load is unloaded at the delivery destination and the present load weight becomes less than the specified value, HEV mode is switched to EV mode. In the above-described embodiment, the vehicle D traveling on the delivery route X4 performs delivery in the order of the delivery destinations D41, D42, D43, D44, D45 (see FIG. 1). For example, when the load weight becomes less than the specified value when the load is unloaded at the delivery destination D42, the vehicle is switched to EV mode after the delivery destination D42 and travels.

As described above, the traveling mode of the vehicle D (PHEV) includes HEV mode in which the vehicle travels using the electric motor 13d and the internal combustion engine 16d, and EV mode in which the vehicle travels using the electric motor 13d without using the internal combustion engine 16d. When the vehicle D is delivering the assigned delivery route, the delivery plan generation apparatus 100 performs a process of traveling in HEV mode when the current load weight of the vehicle D is equal to or greater than the specified value, and transmitting a command to travel in EV mode when the current load weight of the vehicle D is less than the specified value to the vehicle D. Note that this process may be performed by the vehicle D instead of the delivery plan generation apparatus 100.

According to this configuration, the vehicle D travels in HEV mode in which the vehicle D travels by using the electric motor 13d and the internal combustion engine 16d when the currently loaded weight is equal to or greater than a specified value. In the vehicle D, the vehicle D travels in a EV mode in which the vehicle D travels using an electric motor 13d without using an internal combustion engine 16d when the vehicle D is less than a specified value. When the delivery vehicle is PHEV, EV mode is inefficient when the load is heavy, and therefore the mode is switched to EV mode when the load is reduced. Accordingly, it is possible to avoid running in EV mode using only the electric motor in a state where the load weight is large and the electric cost is deteriorated (running in HEV mode), and to run in EV mode in a state where the load weight is small and the electric cost is improved. Note that the mode-specific process illustrated in FIG. 5 may be executed after S15 in the first embodiment.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A delivery plan generation apparatus for generating a delivery plan of a plurality of vehicles that deliver packages, comprising:
a processor; and
a memory that stores a program executable by the processor, wherein
the vehicles include a first vehicle provided with, as a power source, an electric motor without an internal combustion engine, and at least one second vehicle provided with an internal combustion engine as a power source,
delivery routes of the vehicles include a first delivery route and a second delivery route,
a total loading weight of packages loaded on a vehicle when delivery on the second delivery route is started is larger than a total loading weight of packages loaded on a vehicle when delivery on the first delivery route is started, and
the processor performs a process including determining delivery routes of the first vehicle and the at least one second vehicle so as to assign the first delivery route, out of the first delivery route and the second delivery route, preferentially to the first vehicle rather than to the at least one second vehicle.

2. The delivery plan generation apparatus according to claim 1, wherein:
delivery destinations on the first delivery route include a first delivery destination and a second delivery destination;
a weight of a package delivered to the second delivery destination is larger than a weight of a package delivered to the first delivery destination; and
when the first vehicle is assigned to the first delivery route, the processor performs a process including determining delivery order for the first delivery route such that the second delivery destination has a higher priority than the first delivery destination.

3. The delivery plan generation apparatus according to claim 1, wherein:
the delivery routes of the vehicles further include a third delivery route;
a total loading weight of packages loaded on a vehicle when delivery on the third delivery route is started is larger than a total loading weight of packages loaded on a vehicle when delivery on the second delivery route is started;
the at least one second vehicle includes a third vehicle provided with, as a power source, an internal combustion engine without an electric motor, a fourth vehicle provided with an electric motor and an internal combustion engine as power sources without having an external charging function, and a fifth vehicle being externally chargeable and provided with an electric motor and an internal combustion engine as power sources; and
the processor performs a process including determining delivery routes of the third vehicle, the fourth vehicle, and the fifth vehicle such that the second delivery route is preferentially assigned out of the second delivery route and the third delivery route in order of the third vehicle, the fourth vehicle and the fifth vehicle.

4. The delivery plan generation apparatus according to claim 3, wherein:
traveling modes of the fifth vehicle include a first mode in which the fifth vehicle travels using an electric motor and an internal combustion engine, and a second mode in which the fifth vehicle travels using an electric motor without using an internal combustion engine; and
the processor performs a process including transmitting, to the fifth vehicle, a command to travel in the first mode when a current loading weight of the fifth vehicle is equal to or greater than a specified value and a command to travel in the second mode when the current loading weight of the fifth vehicle is less than the specified value while the fifth vehicle is delivering the packages on the assigned delivery route.
